(19) United States
(12) Patent Application Publication
(10) Pub. No.: US 2018/0071988 A1
(43) Pub. Date: Mar. 15, 2018

(54) THREE-DIMENSIONAL PRINTING SYSTEMS

(71) Applicant: HEWLETT-PACKARD DEVELOPMENT COMPANY, L.P., Houston, TX (US)

(72) Inventors: Ali Emamjomeh, San Diego, CA (US); Winthrop Childers, San Diego, CA (US)

(73) Assignee: HEWLETT-PACKARD DEVELOPMENT COMPANY, L.P., Houston, TX (US)

(21) Appl. No.: 15/560,266

(22) PCT Filed: May 15, 2015
(86) PCT No.: PCT/US2015/031001

§ 371 Date: Sep. 21, 2017

(51) Int. Cl. B29C 64/393; B29C 64/165; B29C 64/188; B29C 64/20; B33Y 10/00; B33Y 30/00; B33Y 50/02; G05B 19/4099

(52) U.S. Cl. CPC B29C 64/393; B29C 64/165; B29C 64/188; B29C 64/20; G06T 15/08; B33Y 30/00; B33Y 50/02; G05B 19/4099; B33Y 10/00

(57) ABSTRACT

Examples relate to defining layers for generating three-dimensional objects. In the examples herein, a grid is obtained to represent a layer of a three-dimensional object. A boundary portion of the grid is defined, representing a surface portion of the three-dimensional object. A binding agent load is assigned to the boundary portion based on first pattern. An interior portion of the grid is defined. A coalescing agent load is assigned to the interior portion based on a second pattern.

### BACKGROUND

Additive manufacturing systems that generate three-dimensional objects on a layer-by-layer basis have been proposed as a potentially efficient way to produce three-dimensional objects such as customized articles of manufacture or prototypes. The resolution and material properties of objects produced by such systems may vary widely depending on the type of additive manufacturing technology used.

### BRIEF DESCRIPTION OF THE DRAWINGS

The following detailed description references the drawings, wherein:

FIG. 1 is a block diagram of a computing device according to some examples;

FIG. 2 is a diagram of a system for generating three-dimensional objects according to some examples;

FIG. 3 is a flowchart of a method for generating a three-dimensional object according to some examples;

FIG. 4a shows a cross-sectional side view of a layer of build material according to some examples;

FIG. 4b shows a cross-sectional side view of a layer of build material according to some examples;

FIG. 4c shows a cross-sectional side view of a layer of build material according to some examples;

FIG. 4d shows a cross-sectional side view of a layer of build material according to some examples;

FIG. 5 shows a cross-sectional top view of a layer of build material according to some examples;

FIG. 6 shows a cross-sectional top view of a layer of build material according to some examples;

FIG. 7 shows a cross-sectional top view of a layer of build material according to some examples;

FIG. 8 shows a cross-sectional top view of a layer of build material according to some examples;

FIG. 9 is a schematic diagram of a grid representing a layer of a three-dimensional object; and

FIG. 10 is a schematic diagram of a three-dimensional object sliced into a plurality of layers.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Some additive manufacturing systems generate three-dimensional objects through the solidification of portions of successive layers of build material, such as a powdered or liquid build material. The properties of generated objects may be dependent on the type of build material and the type of solidification mechanism used.

In some examples, solidification may be achieved using of a coalescing agent, which is a material that, when a suitable amount of energy is applied to a combination of build material and coalescing agent, may cause the build material to coalesce and solidify. Coalescence is when particles or masses of the build material bind directly with each other to form a larger mass, for example particles may be thermally fusible such that a rise in temperature may melt, sinter, or both melt and sinter the particles directly together. The build material may, for example, include other components that may aid in coalescence, and in examples in which the build material is powdered, aid in powder flow. In these examples, objects may, for example, achieve high strength. However, such objects may, for example, experience internal tensile stress and/or shrinkage when solidified.

In some examples, solidification may be achieved using a binding agent which binds and solidifies build material into a binding matrix, which is a mixture of generally separate particles or masses of build material that are adhesively bound together by a binding agent, similar to a glue. In these examples, objects may, for example, experience expansion and/or compressive stress when solidified, but may, for example, not achieve high strength. The presence of colorants in binding agents may, in some examples, have little or no effect on binding and solidification.

Furthermore, as described in some examples herein, hybrid systems generate three-dimensional objects both by applying coalescing agent and energy in a first region of the object and applying a binding agent in a second region of the object. This may, for example, allow modulation and optimization of a wide variety of object properties. For example, the tensile stress and shrinkage in the first region may be offset by compressive stress and expansion in the second region. This may also, for example, allow generation of larger objects that exhibit high quality properties including high strength. This may also, for example, allow coloration of objects without affecting any other object properties.

Examples disclosed herein provide for defining layers of a three-dimensional objects for purposes of generating the three-dimensional object. An example non-transitory machine-readable storage medium may contain instructions executable by a processor to define layers. The instructions may obtain a grid representing a layer of a three-dimensional object, where the grid includes a plurality of pixels. The instructions may define a boundary portion of the grid, where the boundary portion represents a surface portion of the three-dimensional object, and the instructions may then assign a binding agent load to the boundary portion based on a first pattern derived from the grid. The instructions may define an interior portion of the grid and then assign a coalescing agent load to the interior portion based on a second pattern derived from the grid. In this manner, when the boundary portion is selectively colored, a three-dimensional object may be generated without an additional color-providing process.

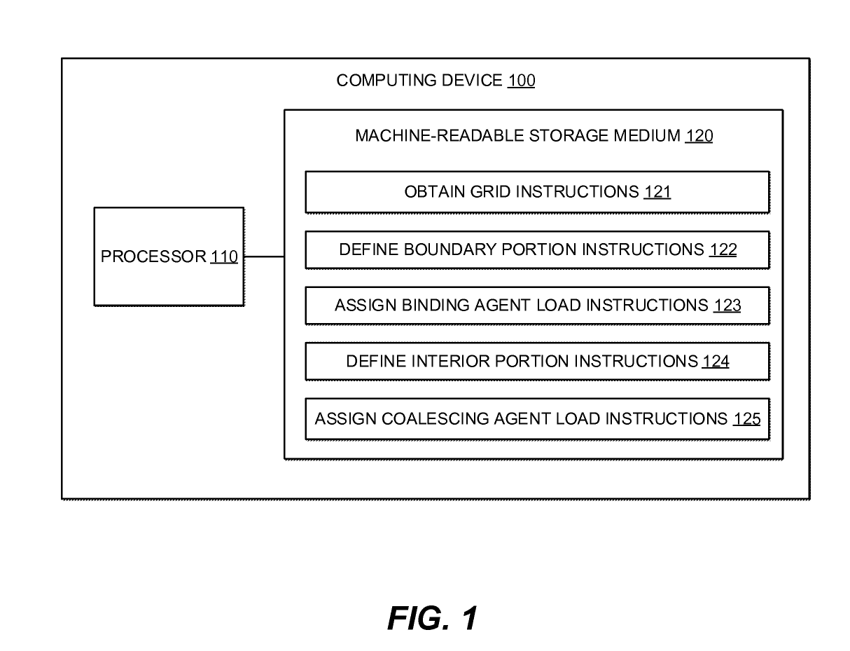

Referring now to the figures, FIG. 1 is a block diagram illustrating a computing device 100 according to some examples. Computing device 100 may be, for example, a cloud server, a local area network server, a web server, a mainframe, a mobile computing device, a notebook or desktop computer, a smart TV, a point-of-sale device, a wearable device, a 3D printer, any other suitable electronic device, or a combination of devices, such as ones connected by a cloud or internet network, that perform the functions described herein. In the example shown in FIG. 1, computing device 100 includes a processor 110 and a non-transitory machine-readable storage medium 120 encoded with instructions to define layers.

Processor 110 may be central processing units (CPUs), semiconductor-based microprocessors, or other hardware devices suitable for retrieval and execution of instructions stored in machine-readable storage medium 120. Processor 110 may fetch, decode, and execute instructions 121, 122, 223, 124, 125, and/or other instructions to implement the procedures described herein. As an alternative or in addition to retrieving and executing instructions, processor 110 may include one or more electronic circuits that include electronic components for performing the functionality of one or more of instructions 121, 122, 123, 124, and 125.

In one example, the program instructions 121, 122, 123, 124, 125, and/or other instructions can be part of an installation package that can be executed by processor 110 to implement the functionality described herein. In this case, storage 120 may be a portable medium such as a CD, DVD, or flash drive or a memory maintained by a computing device from which the installation package can be downloaded and installed. In another example, the program instructions may be part of an application or applications already installed on computing device 100

Machine-readable storage medium 120 may be any electronic, magnetic, optical, or other physical storage device that contains or stores executable data accessible to computing device 100. Thus, machine-readable storage medium 120 may be, for example, a Random Access Memory (RAM), an Electrically Erasable Programmable Read-Only Memory (EEPROM), a storage device, an optical disc, and the like. Storage medium 120 may be a non-transitory storage medium, where the term “non-transitory” does not encompass transitory propagating signals. Storage medium 120 may be located in computing device 100 or in another device in communication with computing device 100. As described in detail below, machine-readable storage medium 120 may be encoded with obtain grid instructions 121, define boundary portion instructions 122, assign binding agent load instructions 123, define interior portion instructions 124, and assign coalescing agent load instructions 125.

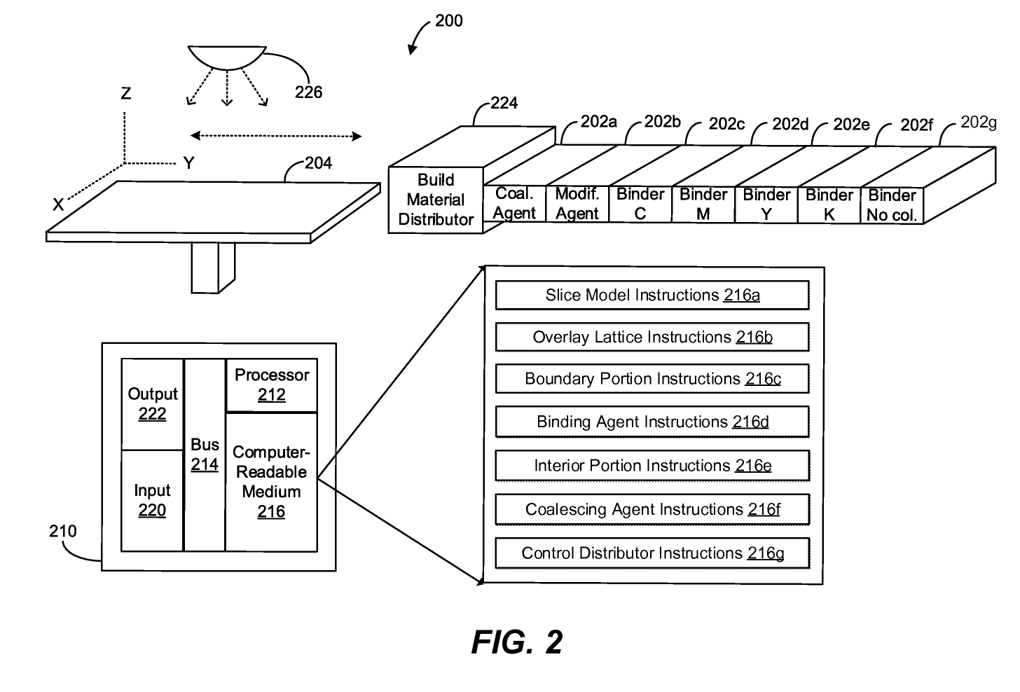

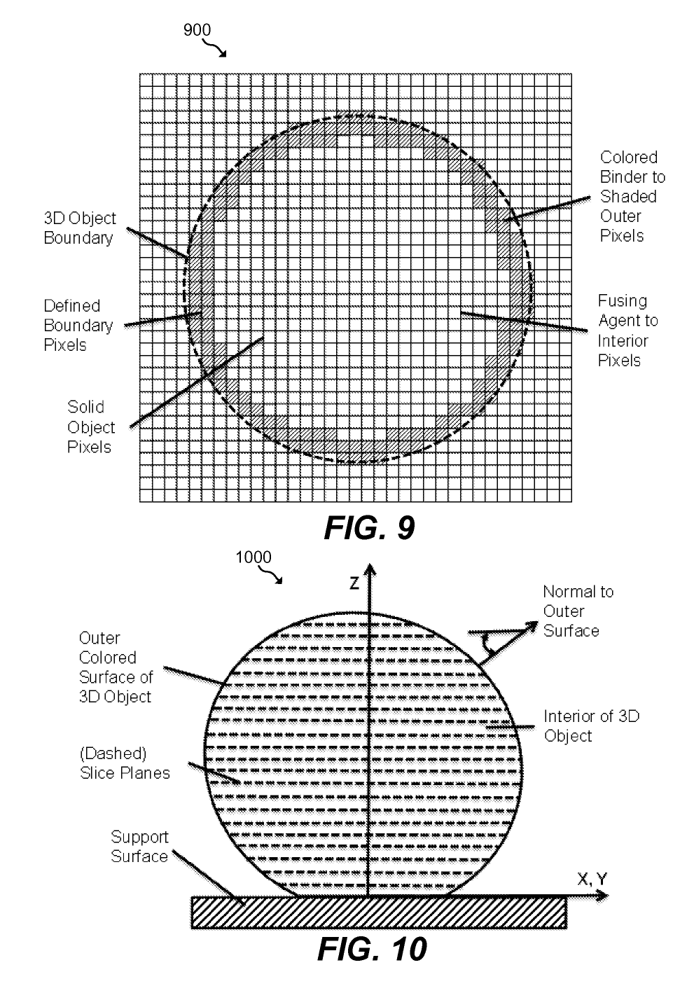

Obtain grid instructions 121, when executed by processor 110, may obtain a grid representing a layer of a three-dimensional object. A grid may comprise a plurality of pixels, which may represent small addressable portions of the layer. The grid may be obtained by overlaying the grid of pixels on the layer of the three dimensional object. The layer may be obtained by slicing the three-dimensional object into a relatively thin sheet that may, for example, be generated by methods described. Grid 900 of FIG. 9 illustrates a circular grid representing a circular layer of an object. Examples of the three-dimensional object include any object that may be generated by processes herein, such as those to be generated by 3D printing. Further details of obtaining the grid are described below in reference to FIG. 2.

Define boundary portion instructions 122, when executed by processor 110, may define a boundary portion of the grid. The boundary portion may represent a surface portion of the three-dimensional object. For example, the boundary portion may be the pixels of the grid that depict the exterior of the three-dimensional object.

Define boundary portion instructions 122 may define the boundary portion by a variety of techniques. For example, the boundary portion may be defined by including pixels that contain an outer boundary of the grid when at least half of the area of a pixel is inside the outer boundary of the grid. Additionally or as an alternative, the boundary portion may include pixels that are adjacent to an outermost pixel of the grid. In other words, these may be pixels that are next to pixels containing the outer boundary of the grid. As an additional example, the boundary portion may include pixels within one pixel of an outermost pixel of the grid. For example, these may be pixels that are separated by one pixel to pixels containing the outer boundary of the grid. Furthermore, the boundary portion may be defined by a combination of techniques, including the three examples above. Grid 900 of FIG. 9 shows an example boundary portion as shaded pixels.

Assign binding agent load instructions 123, when executed by processor 110, may assign a binding agent load to the boundary portion based on a first pattern derived from the grid. The binding agent may include a fluid comprising, for example, an adhesive. In some examples, the binding agent comprises a colorant to provide color on a surface of the three-dimensional object. Further details of the binding agent are described below in reference to FIG. 2.

In some such examples where the binding agent comprises colorants, assign binding agent load instructions 123 may assign the binding agent load to each pixel of the boundary portion by determining an average color of a surface portion of the three-dimensional object represented by each particular pixel. For example, the color of each pixel may be based on the color of the outer surface of the three-dimensional object that is adjacent to that pixel or in line with a unit normal to the outer surface of the object.

For example, the color of the surface of the three-dimensional object may be determined during slicing of the layers. A particular pixel of the boundary portion of the grid may be assigned a color that is an average of the color along that portion of the surface of the three-dimensional object whose normal projection captures the pixel. Furthermore, pixels that are adjacent but further from the surface than that the particular pixel may be assigned approximately the same color to allow a thicker colored surface.

Furthermore, in some examples, assign binding agent load instructions 123 may assign the binding agent load to each pixel of the boundary portion based a location of each particular pixel in relation to the three-dimensional object. For example, as illustrated in FIG. 10, a layer as used herein may be a slice of a three-dimensional object 1000 in the x-axis and the y-axis. Each layer may also have a z-axis location relative to the overall three-dimensional object 1000. An angular difference between the z-axis and a normal vector of a particular pixel in the grid may represent the curve or angle of the particular portion of the outer surface of the three-dimensional object. Accordingly, the binding agent load may be adjusted accordingly, based on, for example, saturation rates of the material of the three-dimensional object to the generated as well as the properties of the binding agent.

Define interior portion instructions 124, when executed by processor 110, may define an interior portion of the grid. The interior portion of the grid may represent an interior or body portion of the three-dimensional object. In some examples, the interior portion and the boundary portion of the grid are non-overlapping. In such examples, a clear border between the two portions may be generated in the layer. Grid 900 of FIG. 9 illustrates an example interior portion.

Assign coalescing agent load instructions 125, when executed by processor 110, may assign a coalescing agent load to the interior portion based on a second pattern derived from the grid. According to examples, a suitable coalescing agent may be a printing fluid, such as an ink-type formulation comprising carbon black. In some examples the coalescing agent may comprise a liquid carrier, such as water or any other suitable solvent or dispersant. Further details of the coalescing agent are described below in reference to FIG. 2.

In some examples, storage medium 120 may further include instructions to assign a binding agent load to the interior portion. This may be done, for example, to alter the properties of the interior portion of the three-dimensional object. For example, storage medium 120 may have instructions to assign a clear binding load to the interior portion based on the second pattern.

Furthermore, in some examples, storage medium 120 may further include instructions to assign a build material load to the interior portion based on a third pattern derived from the grid. In some examples, build material may be selected to facilitate coalescing using a coalescing agent and binding using a binding agent in order to generate the layer of the three-dimensional object. In some examples, a mixture of two build materials may be selected such that one build material facilitates coalescing using the coalescing agent and the other build material facilitates binding using a binding agent. In some examples the build material may be a powder-based build material. Further details of the build material are described below in reference to FIG. 2.

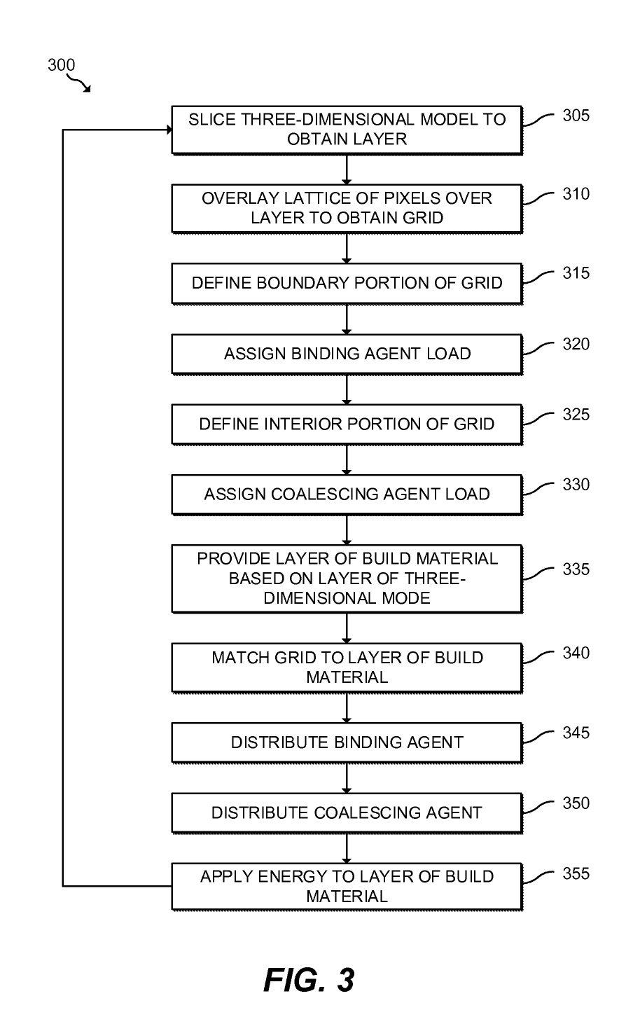

FIG. 2 is a diagram of a system for generating three-dimensional objects according to some examples. The system 200 may be operated, as described further below with reference to the flow diagram of FIG. 3 to generate a three-dimensional object.

In some examples, build material may be selected to facilitate coalescing using a coalescing agent and binding using a binding agent. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable powdered build material may be Nylon 11 (polyamide 11) or Nylon 12 (polyamide 12), which are available, for example, from Sigma-Aldrich Co. LLC, and which may be suitable for coalescence using of coalescing agent and binding using binding agent. Another suitable Nylon 12 material may be PA 2200 which is available from Electro Optical Systems EOS GmbH. Another suitable powdered build material may be calcium hemihydrate, which may be suitable for binding using a binding agent. Other examples of suitable build materials may include, for example, powdered metal materials, powdered composite materials, powdered ceramic materials, powdered glass materials, powdered resin material, powdered polymer materials, and the like, and combinations thereof. Other examples of suitable build materials may include powdered polymers that are amorphous, semi-crystalline, crystalline, and/or combinations thereof. In some examples, the build material may comprise a polymer including phenylethene (styrene), acrylates, polyethylenes, polyolefins, polyesters, polyurethanes, polypropylenes, acrylics, polyaryletherketone, various amides, various amines, other suitable polymers, and/or combinations thereof. In some examples, amorphous build materials may be used, e.g. acrylonitrile butadiene styrene (ABS) or polycarbonate. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material. In some examples, any mixtures or combinations of the above build materials may be used.

System 200 may include a system controller 210. Any of the operations and methods disclosed herein may be implemented and controlled by controller 210.

Controller 210 may include a processor 212 for executing instructions that may implement the methods described herein. Processor 212 may, for example, be a microprocessor, a microcontroller, a programmable gate array, an application specific integrated circuit (ASIC), a computer processor, or the like. Processor 212 may, for example, include multiple cores on a chip, multiple cores across multiple chips, multiple cores across multiple devices, or combinations thereof. In some examples, processor 212 may include at least one integrated circuit (IC), other control logic, other electronic circuits, or combinations thereof.

Controller 210 may support direct user interaction. For example, system 200 may include user input devices 220 coupled to processor 212, such as a keyboard, touchpad, buttons, keypad, dials, mouse, track-ball, card reader, or other input devices. Additionally, system 200 may include output devices 222 coupled to processor 212, such as a liquid crystal display (LCD), video monitor, touch screen display, a light-emitting diode (LED), or other output devices. Output devices 222 may be responsive to instructions to display textual information or graphical data.

Processor 212 may be in communication with a computer-readable storage medium 216 via a communication bus 214. Computer-readable storage medium 216 may include a single medium or multiple media. For example, computer readable storage medium 216 may include one or both of a memory of the ASIC, and a separate memory in controller 210. Computer readable storage medium 216 may be any electronic, magnetic, optical, or other physical storage device. For example, computer-readable storage medium 216 may be, for example, random access memory (RAM), static memory, read only memory, an electrically erasable programmable read-only memory (EEPROM), a hard drive, an optical drive, a storage drive, a CD, a DVD, and the like. Computer-readable storage medium 216 may be non-transitory. Computer-readable storage medium 216 may store, encode, or carry computer executable instructions 216a-g that, when executed by processor 212, may cause processor 212 to perform any of the methods or operations disclosed herein according to various examples.

Storage medium 216 may include slice model instructions 216a, overlay lattice instructions 216b, boundary portion instructions 216c, binding agent instructions 216d, interior portion instructions 216e, coalescing agent instructions 216f, and control distributor instructions 216g. Instructions 216c-f may be executable by processor 212 and may be analogous to instructions 122-125 of FIG. 1.

Slice model instructions 216a may, when executed by processor 212, slice a three-dimensional model of the three-dimensional object to obtain a layer of the three-dimensional object. As used herein, a layer of the three-dimensional object may mean digital representation of a physical sheet of the three-dimensional object. For example, the layer may represent a relatively flat portion of the overall object. For example, the layer may extend the entire or a significant portion of the object in the x-axis and the y-axis but may be small in the z-axis.

Overlay lattice instructions 216b, when executed by processor 212, may overlay a lattice of pixels over the layer to obtain the grid representing the layer of the three-dimensional object. As described previously, the lattice of pixels of the grid may represent small addressable portions of the layer.

Boundary portion instructions 216c, binding agent instructions 216d, interior portion instructions 216e, and coalescing agent instructions 216f may be analogous with define boundary portion instructions 122, assign binding agent load instructions 123, define interior portion instructions 124, and assign coalescing agent load instructions 125 of FIG. 1, respectively.

Control distributor instructions 216g, when executed by processor 212, may control distributors to generate the three-dimensional object, which is illustrated below with reference to build material distributor 224 and distributors 202a-g as shown in FIG. 2.

Control distributor instructions 216g may control a coalescing agent distributor 202a to selectively deliver coalescing agent to successive layers of build material provided on a support member 204. According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light absorbers are dye based colored ink and pigment based colored ink, such as inks commercially known as CM993A and CE042A available from Hewlett-Packard Company. In some examples the coalescing agent may comprise a liquid carrier, such as water or any other suitable solvent or dispersant.

Control distributor instructions 216g may control agent distributors 202c-g to selectively deliver binding agents to successive layers of build material provided on a support member 204. According to one non-limiting example, a suitable agent may include a fluid (e.g. liquid) comprising, for example, an activation agent, e.g an adhesive such as polyvinyl alcohol (PVOH), polyvinyl acetate (PVA) or polymeric resin. The adhesive may comprise about 5 to about 50 percent of the weight of the agent. The binding agent may, for example, also include a non-reactive polymer that may comprise about 5 to about 50 percent of the weight of the agent. The binding agent may, for example, also include a colorant such as a dye or pigment. In the example of FIG. 2, the colorants included in each respective agent delivered by respective agent distributors 202c-f are cyan (C), magenta (M), yellow (Y), and black (K) colorants according to a subtractive color model, for example, if such agents are used to provide color on borders of a generated object. The agent delivered by agent distributor 202g may not include a colorant, for example if the agent is used to generate portions of an interior of an object. In some examples, the binding agents may each, for example, also include a liquid carrier, such as water or any other suitable solvent or dispersant. In some examples, an additional agent distributor may be to deliver a binding agent having a white (W) colorant.

In some examples, the adhesive may be included in the build material rather than in the binding agent. For example, the build material may include a powder (e.g. a polymer powder such as polyamide 11 or 12), amorphous build material, or other type of build material. The build material may, for example, comprise about 45 to about 70 percent of the weight of the build material. The build material may, for example, also include an activatable agent (e.g. an adhesive such as polyvinyl alcohol, polyvinyl acetate, or polymeric resin) that may comprise about 4 to about 8 percent of the weight of the build material. The build material may, for example, also include a plaster that may comprise about 25 to about 45 percent of the weight of the build material. The build material may, for example, also include an accelerator that may comprise about 1 to about 3 percent of the weight of the build material. Inclusion of the accelerator may, for example, increase the speed of binding. The adhesive, plaster, and accelerator may be interspersed in the powder, or may be formed as a thin reactive coating on the surface of each layer of delivered powder. Thus, in these examples, the binding agent may comprise a fluid (e.g. water) that may activate the adhesive in the build material when the agent is delivered to the build material, such that the build material having the adhesive and delivered binding agent (e.g. fluid) binds and solidifies into a binding matrix. The adhesive may be soluble in the delivered fluid of the binding agent.

Control distributor instructions 216g may control a binding modifier agent distributor 202b to selectively deliver binding modifier agent to a layer of build material provided on the support member 204. A binding modifier agent may serve to modify, e.g. increase or reduce, the degree of binding of a portion of build material on which the binding modifier agent has been delivered or has penetrated. Different physical and/or chemical effects may be used to modify the effects of a binding agent. An example of a binding modifier agent that may reduce the degree of binding may, for example, be a repellant such as a fluid with wax particles. In some examples the binding modifier agent may comprise a liquid carrier, such as water or any other suitable solvent or dispersant.

In one example the support member 204 has dimensions in the range of from about 10 cm by 10 cm up to 100 cm by 100 cm. In other examples the support member 204 may have larger or smaller dimensions. The support member 204 may be a fixed part of the system 200, or may not be a fixed part of the system 200, instead being, for example, a part of a removable module.

Agent distributors 202a-g may be printheads, such as thermal printheads or piezo inkjet printheads. The printheads may have arrays of nozzles. In one example, printheads such as those commonly used in commercially available inkjet printers may be used. In other examples, the agents may be delivered through spray nozzles rather than through printheads. Other delivery mechanisms may be used as well.

Control distributor instructions 216g may control agent distributors 202a-g to selectively deliver, e.g. deposit, the agents when in the form of suitable fluids such as liquids. In some examples, agent distributors 202a-g may be selected to deliver drops of agent at a resolution of between 300 to 1200 dots per inch (DPI), for example 600 DPI. In other examples, agent distributors 202a-g may be selected to be able to deliver drops of agent at a higher or lower resolution. In some examples, agent distributors 202a-g may have an array of nozzles through which agent distributors 202a-g are able to selectively eject drops of fluid. In some examples, each drop may be in the order of about 10 pico liters (pl) per drop, although in other examples agent distributors 202a-g that are able to deliver a higher or lower drop size may be used. In some examples, agent distributors that are able to deliver variable size drops may be used. In some examples the printhead may be a drop-on-demand printhead. In other examples the printhead may be a continuous drop printhead.

In some examples, agent distributors 202a-g may be an integral part of system 200. In some examples, agent distributors 202a-g may be user replaceable, in which case they may be removable and insertable into suitable agent distributor receivers or interfaces of system 200.

In some examples a single agent distributor, such as a printhead, may be used to selectively deliver multiple agents. For example, different sets of nozzles may be to deliver different agents.

In the example illustrated in FIG. 2, agent distributors 202a-g have a length that enables them to span the whole width of support member 204 in a so-called page-wide array configuration. In one example this may be achieved through a suitable arrangement of multiple printheads. In other examples a single printhead having an array of nozzles having a length to enable them to span the width of support member 204 may be used. In other examples, agent distributors 202a-g may have a shorter length that does not enable them to span the whole width of support member 204.

Agent distributors 202a-g may be mounted on a moveable carriage to enable them to move bi-directionally across the length of the support member 204 along the illustrated y-axis. This enables selective delivery of agents across the whole width and length of support member 204 in a single pass. In other examples agent distributors 202a-g may be fixed, and support member 204 may move relative to agent distributors 202a-g.

It should be noted that the term ‘width’ used herein is used to generally denote the shortest dimension in the plane parallel to the x and y axes illustrated in FIG. 2, whilst the term ‘length’ used herein is used to generally denote the longest dimension in this plane. However, it will be understood that in other examples the term ‘width’ may be interchangeable with the term ‘length’. For example, in other examples agent distributors 202a-g may have a length that enables them to span the whole length of support member 204 whilst the moveable carriage may move bi-directionally across the width of support 204.

In other examples, agent distributors 202a-g do not have a length that enables them to span the whole width of support member 204 but are additionally movable bi-directionally across the width of support member 204 in the illustrated x-axis. This configuration enables selective delivery of agents across the whole width and length of support 204 using multiple passes. Other configurations, however, such as a page-wide array configuration, may enable three-dimensional objects to be created faster.

Control distributor instructions 216g may further control a build material distributor 224 to provide, e.g. deliver or form, successive layers of build material on support member 204. Suitable build material distributors 224 may include, for example, a wiper blade and a roller. Build material may be supplied to build material distributor 224 from a hopper or build material store. In the example shown, build material distributor 224 moves across the length (y-axis) of support member 204 to deposit a layer of build material. As previously described, a layer of build material will be deposited on support member 204, whereas subsequent layers of build material will be deposited on a previously deposited layer of build material. Build material distributor 224 may be a fixed part of system 200, or may not be a fixed part of system 200, instead being, for example, a part of a removable module. In some examples, build material distributor 224 may be mounted on carriages.

In some examples, the build material distributor 224 may be to provide a layer of build material having a thickness in the range of between about 20 to about 200 microns, or about 50 to about 300 microns, or about 90 to about 110 microns, or about 25 microns, or about 50 microns, or about 75 microns, or about 100 microns, or about 250 microns, although in other examples thinner or thicker layers of build material may be provided. The thickness may be controlled by the controller 210, for example based on the instructions 218, including for example object design data defining the three-dimensional object to be generated.

In some examples, there may be any number of additional agent distributors and build material distributors relative to the distributors shown in FIG. 2. In some examples, the distributors of system 200 may be located on the same carriage, either adjacent to each other or separated by a short distance. In other examples, two or more carriages each may contain distributors. For example, each distributor may be located in its own separate carriage. Any additional distributors may have similar features as those discussed earlier with reference to agent distributors 202a-g.

In the example shown, support member 204 is moveable in the z-axis such that as new layers of build material are deposited a predetermined gap is maintained between the surface of the most recently deposited layer of build material and lower surfaces of agent distributors 202a-g. In other examples, however, support member 204 may not be movable in the z-axis, and agent distributors 202a-g may be movable in the z-axis.

System 200 may additionally include an energy source 226. Energy source 226 may apply energy to build material to cause the solidification of portions of the build material according to where coalescing agent has been delivered or has penetrated. In some examples, a portion of build material having binding agent may be curable to form a binding matrix in response to application of energy, e.g. ultraviolet (UV) energy. However, in other examples the portion having binding agent may solidify into a binding matrix without application of energy for curing or drying. In examples in which the portion having binding agent is curable, energy source 226 may also be to cure or dry the portion having binding agent to solidify the portion into a binding matrix.

In some examples, energy source 226 is an infra-red (IR) radiation source, near infra-red radiation source, visible light source, microwave energy source, ultraviolet (UV) radiation source, halogen radiation source, or a light emitting diode. In some examples, energy source 226 may be a single energy source that is able to uniformly apply energy to build material deposited on support 204. In some examples, energy source 226 may comprise an array of energy sources.

In some examples, energy source 226 may be a single energy source that is able to uniformly apply energy to build material. In some examples, energy source 226 may comprise an array of energy sources. In some examples, energy source 226 may include a first energy source to apply suitable energy to cause solidification of portions of build material according to where coalescing agent has been delivered or penetration, and a second energy source to apply suitable energy, e.g. UV energy, to cure or dry a portion having binding agent into a solidified binding matrix.

In some examples, energy source 226 is configured to apply energy in a substantially uniform manner to the whole surface of a layer of build material. In such examples, energy source 226 may be said to be an unfocused energy source. In these examples, a whole layer may have energy applied thereto simultaneously, which may help increase the speed at which a three-dimensional object may be generated.

In other examples, energy source 226 is configured to apply energy in a substantially uniform manner to a portion of the whole surface of a layer of build material. For example, energy source 226 may be configured to apply energy to a strip of the whole surface of a layer of build material. In these examples the energy source may be moved or scanned across the layer of build material such that a substantially equal amount of energy is ultimately applied across the whole surface of a layer of build material.

In some examples, controller 210 may control the energy source to apply energy to portions of build material on which coalescing agent has been applied or to portions having binding agent or both, but not to portions on which coalescing agent has not been applied or which do not have a binding agent.

In further examples, energy source 226 may be a focused energy source, such as a laser beam. In this example the laser beam may be controlled to scan across the whole or a portion of a layer of build material. In these examples the laser beam may be controlled to scan across a layer of build material in accordance with agent delivery control data. For example, the laser beam may be controlled to apply energy to those portions of a layer of on which coalescing agent is delivered and/or portions having a binding agent.

The combination of the energy supplied, the build material, and the coalescing agent, binding modifier agent, and binding agent may be selected such that: i) portions of the build material on which no coalescing agent have been delivered do not coalesce when energy is temporarily applied thereto; ii) portions of the build material on which there is no binding agent do not form a binding matrix; iii) portions of the build material having a binding agent but not binding modifier agent solidifies into a binding matrix, either with or without application of curing energy, depending on whether the portion having binding agent uses curing to solidify; iv) portions of the build material having a coalescing agent and binding agent, but not binding modifier agent, coalesces upon application of energy and also bind into a binding matrix either with or without application of curing energy, depending on whether the build material and binding agent uses curing to bind; v) portions of the build material having binding modifier agent but not coalescing agent nor binding agent do not coalesce or bind when energy is temporarily applied thereto; vi) portions of the build material having both binding agent and binding modifier agent may undergo a modified, e.g. increased or reduced, degree of binding, for example to modulate or tune mechanical properties of these portions.

In some examples, system 200 may additionally comprise a pre-heater to maintain build material deposited on support member 204 within a predetermined temperature range. Use of a pre-heater may help reduce the amount of energy that has to be applied by energy source 226 to cause coalescence and subsequent solidification of build material on which coalescing agent has been delivered or has penetrated.

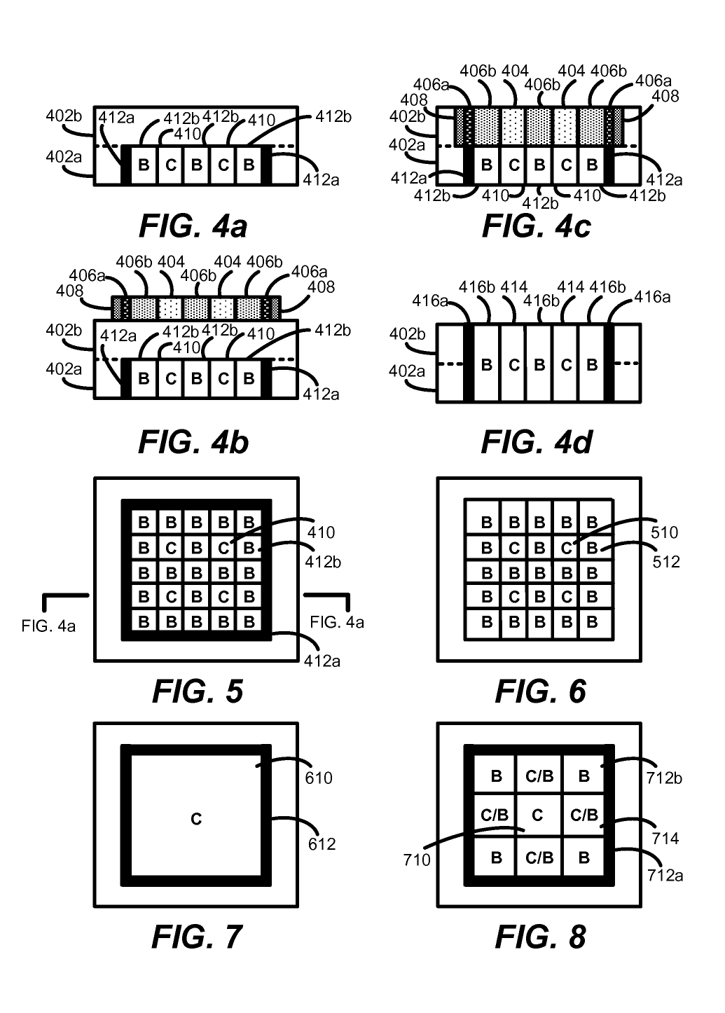

FIG. 3 is a flow diagram illustrating a method 300 of generating a three-dimensional object according to some examples. Aspects of the method may be computer implemented. In some examples, the orderings shown may be varied, some elements may occur simultaneously, some elements may be added, and/or some elements may be omitted. In describing FIG. 3, reference will be made to FIGS. 2, 4a-4d, and 5. FIG. 4a-d show a series of cross-sectional side views of layers of build material according to some examples. FIG. 5-8 show cross-sectional top view of layers of build material according to some examples.

Iterations of operation 305 to operation 355 may be performed to generate a three-dimensional object, as will be described. Operation 305 to operation 330 may be performed to define a layer of the three-dimensional object. Operation 335 to operation 355 may be performed to physically generate the layer of the three-dimensional object.

Operations 305 to 330 may define for each slice of the three-dimensional object to be generated the portions or the locations on the build material, if any, at which the various agents are to be delivered, thereby defining the layer. For example, operation 305 may be performed by instructions 216a of FIG. 2, operation 310 may be performed by instructions 216b, operation 315 may be performed by instructions 216c, operation 320 may be performed by instructions 216d, operation 325 may be performed by instructions 216e, and operation 330 may be performed by instructions 216f. Furthermore, as another example, operations 305 and 310 may be performed by instructions 121 of FIG. 1.

In some examples, the layer may be defined based on object design data representing a three-dimensional model of an object to be generated or from object design data representing properties of the object. For example, the object may be represented by the three-dimensional model shown in FIG. 10. The model may define the solid portions of the object, and may be processed by a three-dimensional object processing system to generate slices of parallel planes of the model, represented in FIG. 10 by dashed horizontal lines. Each slice may define a portion of a respective layer of build material that is to be solidified by the manufacturing system. The object property data may define properties of the object such as density, surface roughness, strength, and the like.

The object design data and object property data may be received, for example, from a user via an input device 220, as input from a user, from a software driver, from a software application such as a computer aided design (CAD) application, or may be obtained from a memory storing default or user-defined object design data and object property data.

The layer, such as one represented in FIG. 9, may be defined by describing, for each layer of build material to be processed, locations or portions on the build material at which the various agents are to be delivered by agent distributors 202a-g. In one example the locations or portions of the build material at which the agents are to be delivered are defined by way of respective patterns. As shown in FIG. 9 shows the boundary portion of the layer as dashed pixels, while the interior portion is shown by blank pixels inside the dashed line, which represents the exterior boundary of the slice.

Furthermore, FIG. 5 is a cross-sectional top view of a layer 402a of a build material provided by a build material distributor 224 and which has been solidified by applying agents and energy, as described with reference to FIG. 2. FIG. 4a represents a cross section taken through 4a-4a of FIG. 5. In FIGS. 4a-4d and 5, as well in other examples shown in FIG. 6-8, the portions 412b, 512, and 712b labeled “B” are portions of build material that have received a binding agent 406b lacking colorant, the portions 410, 510, 610, and 710 labeled “C” are those that have received a coalescing agent 404, and portions 714 that are labeled “C/B” are those that have received both a coalescing agent 404 and a binding agent 406b lacking colorant. The “B” and “C” portions in FIG. 4a are therefore cross-sectional representations of the “B” and C″ portions of FIG. 5. In FIGS. 4a-d and 5, the portions 412a are portions of build material that have received a binding agent 406a having colorant. Portions of the build material may also receive binding modifier agent 408, as shown in FIGS. 4a-d and 5.

In FIG. 5, adjacent portions of which one contains a “B” and the other contains a “C” are non-overlapping portions in which a binding agent or a coalescing agent are respectively delivered. The lines between the “B” and C″ portions may represent a zone which is of zero width or may have a finite width. In the example of finite width, each line may represent a thin portion of build material on which no binding agent or coalescing agent is delivered, or may instead be a “C/B” portion in which both coalescing agent and binding agent are delivered, such that there some overlap between the binding agent and the coalescing agent.

At 335, a layer 402b of build material may be provided, as shown in FIG. 4a and FIG. 5. For example, the controller 210 may control the build material distributor 224 to provide the layer 402b on a previously completed layer 402a on the support member 204 by causing the build material distributor 224 to move along the y-axis as discussed earlier. The completed layer 402a, as shown in FIGS. 4a and 5, may include patterns of solidified portions 410, 412a, and 412b. The interior solidified portions 410 (labeled with a “C”) may be portions on which coalescing agent and energy was applied thereto to coalesce and solidify the portions. The exterior solidified portions 412a (labeled with a “B”) may be portions on which binding agents having colorants, e.g. any combination of one, two, three, or four CMYK binding agents from agent distributors 202c-202f, were applied thereto to bind and solidify the portions into binding matrices that provide a color on the exterior of the object. The interior solidified portions 412b may be portions on which binding agents lacking colorants, e.g. from agent distributor 202g, were applied thereto to bind and solidify the portions into binding matrices in the interior of the object.

As shown, the portions 412b solidified using binding agent may form a single contiguous filled area in the interior. By contrast, the portions 410 solidified using coalescing agent may be multiple scattered domains within the single contiguous filled area defined by portions 412b. In other examples, portions solidified using coalescing agent may instead form the contiguous fill, and the portions solidified using binding agent may be scattered domains within the contiguous fill of the portions solidified using coalescing agent.

Although a completed layer 402a is shown in FIG. 4a-d for illustrative purposes, it is understood that operations 335 to 355 may initially be applied to generate the layer 402a. Moreover, although not shown, additional layers may have been generated prior to layer 402a, including a layer defining a bottom exterior boundary of the object generating using the CMYK binding agents.

At operation 340 to operation 350, as shown in FIG. 4b, coalescing agent 404, binding agent 406a having colorant (e.g. any combination of one, two, three, or four CMYK binding agents), binding agent 406b lacking colorant, and binding modifier agent 408 may be selectively delivered to the surface of portions of the layer 402b. As discussed earlier, the agents may be delivered by agent distributor 202a-g, for example in the form of fluids such as liquid droplets. As discussed earlier, the binding agents 406a-b may include an adhesive, or instead, the build material may include the adhesive.

The coalescing agent 404, binding agents 406a-b, and binding modifier agent 408 may be delivered in patterns on the portions of the layer 402b that the agent delivery control data 208 may define to become solid to form part of the three-dimensional object being generated. The agent delivery control data 208 may be derived from a model of a three-dimensional object to be generated. “Selective delivery” means that agent may be delivered to selected portions of the surface layer of the build material in various patterns.

In some examples, coalescing agent 404 may be selectively delivered to a portion of build material according to a first pattern, binding agent 406a may be selectively delivered to a portion of build material according to a second pattern, binding agent 406b may be selectively delivered to a portion of build material according to a third pattern, and binding modifier agent 408 may be selectively delivered to a portion of build material according to a fourth pattern. In the example of FIGS. 4a-d and 5, the patterns in layer 402b are the same as the patterns in layer 402a, however in other examples they may vary on a layer-to-layer basis.

FIG. 4c shows the agents 404, 406a-b, and 408 having penetrated into the portions of the layer 402b of build material. The degree to which the agents penetrate may differ between the different agents, or may be substantially the same. FIG. 4c shows the agents 404, 406a-b, and 408 having penetrated substantially completely into the portions of the layer 402b of build material, but in other examples, the degree of penetration may be less than 100%. The degree of penetration may depend, for example, on the quantity of agent delivered, on the nature of the build material, on the nature of the agent, etc.

Although for illustrative purposes the delivery and penetration of each agent is shown to occur substantially at a similar time, in other examples the agents may be delivered in any other order, including but not limited to: (i) 406a, then 406b, then 404, then 408; (ii) 406a, then 406b, then 408, then 404; (iii) 404, then 406a, then 406b, then 408; (ii) 404, then 408, then 406a, then 406b; (ii) 408, then 404, then 406a, then 406b; or (ii) 408, then 406a, then 406b, then 404.

At 355, a predetermined level of energy may be temporarily applied to the layer 402b of build material. In various examples, the energy applied may be infra-red or near infra-red energy, visible light, microwave energy, ultra-violet (UV) light, halogen light, ultra-sonic energy, or the like. The temporary application of energy may cause the portions of the build material on which coalescing agent 404 was delivered to heat up above the melting point of the build material and to coalesce. In some examples, the energy source may be focused. In other examples, the energy source may be unfocused, and the temporary application of energy may cause the portions of the build material on which coalescing agent 404 has been delivered or has penetrated to heat up above the melting point of the build material and to coalesce. For example, the temperature of some or all of the layer 402b may achieve about 220 degrees Celsius. Upon cooling, the portions having coalescing agent 404 may become solid and form part of the three-dimensional object being generated, as shown in FIG. 4d.

In some examples, temporary application of energy, e.g. UV light, may cause portions of the build material on which binding agent 406a-b is present to be cured or dried into a binding matrix, as discussed earlier. This may be done using the same or different energy source as the energy source used to cause portions having coalescing agent to coalesce. The energy applied for curing or drying may be applied before, at the same time as, or after the energy applied for coalescence.

However, in other examples, portions of build material on which binding agents 406a-b are delivered and penetrated may bind and solidify into a binding matrix without any application of energy.

In some examples, in an effect called “bleed”, some adhesive of the binding agent 406a may propagate outwardly into build material to solidify portions that are not intended to be solidified. By applying binding modifier agent 408 around the exterior of the boundary defined by the binding agent 406a, binding in these undesired regions may be reduced or prevented, thus providing greater accuracy and superior exterior surface properties on the object.

As discussed earlier, solidified portions including portions 410 and 412a-b may have been generated in a previous iteration of method 300. The heat absorbed during the application of energy may propagate to the previously solidified portions 410 to cause part of portions 410 to heat up above their melting point. Additionally, the portions 412a-b having binding matrices in layers 402a may bind with newly created binding matrices in layer 402b to create solidified portions 416a-b. These effects help create solidified portions having strong interlayer bonding between adjacent layers of solidified build material, as shown in FIG. 4d.

After a layer of build material has been processed as described above, new layers of build material may be provided on top of the previously processed layer of build material. In this way, the previously processed layer of build material acts as a support for a subsequent layer of build material. Method 300 may then be repeated to generate a three-dimensional object layer by layer.

The three-dimensional object generated using method 300 may, for example, allow modulation and optimization of object properties. In some examples, the solidified portions 414 using coalescing agent may act as strengthening fibers that may be intertwined throughout the three-dimensional interior of the object, but may be limited in volume and may be isolated from each other so as to avoid object shrinkage and tensile stress. Meanwhile, the expansion and compressive stress of portions 412a-b may compensate for the shrinkage in the portions 414 and may allow for greater accuracy when generating large objects. The method 300 may, for example, also allow high quality color, e.g. on the boundary of the object, without affecting other object properties. In some examples, the elastic modulus in different portions of the object may be controllably variable such that different portions may have different elastic moduli.

FIG. 6 shows a cross-section of an object similar to the object shown in FIGS. 4a-d and 5. For example, the object includes portions 512 solidified using binding agent 406b lacking colorant and portions 510 solidified using coalescing agent 404. However, in this example, binding agents 406a having colorants are not applied to the exterior boundary of the object, for example because a colored object is not desired. The agents 404 and 406b may be delivered in patterns on the portions of layers that the agent delivery control data 208 may define to become solid to form part of the three-dimensional object being generated.

FIG. 7 shows a cross-section of an object similar to the object shown in FIGS. 4a-d and 5. For example, the object includes portions 612 solidified using binding agents 406a having colorants and portion 610 solidified using coalescing agent 404. However, in this example, the portion 610 comprises the entire object interior, therefore no binding agents 406b are used in the object interior. The agents 404 and 406a may be delivered in patterns on the portions of layers that the agent delivery control data 208 may define to become solid to form part of the three-dimensional object being generated.

FIG. 8 shows a cross-section of an object similar to the object shown in FIGS. 4a-d and 5. For example, the object includes interior portions 712b solidified using binding agent 406b lacking colorant, exterior boundary portions 712a solidified using binding agents 406a having colorants, and portions 710 solidified using coalescing agent 404. However, in this example, there are additional portions 714 solidified using both binding agent 406b and coalescing agent 404, such that the portions 714 experience solidify through a combination of coalescence and binding into a binding matrix. The agents 404 and 406a-b may be delivered in patterns on the portions of layers that the agent delivery control data 208 may define to become solid to form part of the three-dimensional object being generated.

In an example, a system such as that shown in FIG. 2 may be used except that the system may not include the binding modifier agent distributor 202b. The coalescing agent may include an infrared (IR) light absorber. The binding agents may each include aqueous fluids including a polyvinyl acetate (PVA) adhesive or polyvinyl alcohol (PVOH) adhesive. The build material may include powdered polyamide 12 of thermally fusible particles, and/or adhesion promoters such as plaster particles and accelerator particles which may facilitate the PVA in bonding with the powder particles. The binding agents may, for example, also respectively include a colorant which can be one of black (K), white (W), cyan (C), yellow (Y), magenta (M), colorants with different colors, or no colorant. The binding agents may or may not be UV curable. In examples in which the binding agents achieve binding without UV energy, the energy source may include an IR energy source to cause the portions with coalescing agent to coalesce. In examples in which the binding agents are UV curable, the energy source may include an IR energy source for coalescing agent and a UV energy source for binding agent. Each layer of powder may be in a thickness range of about 50 to about 150 microns. Layers may be solidified using the method 300 of FIG. 3. For example, binding agents with colorants may be provided on the exterior of the object. Additionally, some layers of an object may include both binding agent (without colorant) and coalescing agent in non-overlapping portions in the interior as shown in FIGS. 4a-4d and 5, whereas other layers of the object may include binding agent (without colorant) in the interior but not coalescing agent, and yet other layers of the object may include coalescing agent in the interior but not binding agent (without colorant). In some examples, in some interior portions there may be overlap such that a portion may receive both coalescing agent and binding agent (without colorant). The resulting object may have an arrangement of non-overlapping portions in three dimensions in which the powder particles are either coalesced, e.g. directly fused together, or bound, e.g. indirectly fused together. The delivery of agents may be based on agent delivery control data.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

What is claimed is:

1. A three-dimensional printing system, comprising a non-transitory machine-readable storage medium encoded with instructions executable by a processor, the non-transitory storage medium comprising instructions to:
obtain a grid representing a layer of a three-dimensional object, wherein the grid comprises a plurality of pixels;
define a boundary portion of the grid, wherein the boundary portion represents a surface portion of the three-dimensional object;
assign a binding agent load to the boundary portion based on a first pattern derived from the grid;
define an interior portion of the grid; and
assign a coalescing agent load to the interior portion based on a second pattern derived from the grid.

2. The three-dimensional printing system of claim 1, the non-transitory storage medium further comprising instructions to:
slice a three-dimensional model to obtain the layer of the three-dimensional object; and
overlay a lattice of pixels over the layer to obtain the grid.

3. The three-dimensional printing system of claim 1, the non-transitory storage medium further comprising instructions to assign a build material load to the interior portion based on a third pattern derived from the grid.

4. The three-dimensional printing system of claim 1, the non-transitory storage medium further comprising instructions to assign a binding load to the interior portion based on the second pattern.

5. The three-dimensional printing system of claim 1, wherein a portion of the boundary portion is non-overlapping with the interior portion and a portion of the interior portion is non-overlapping with the boundary portion.

6. The three-dimensional printing system of claim 1, wherein the boundary portion is defined by at least one of:
pixels containing an outer boundary of the grid when at least half of the area of the pixel is inside the outer boundary;
pixels adjacent to an outermost pixel of the grid; and
pixels within one pixel of an outermost pixel of the grid.

7. The three-dimensional printing system of claim 1, wherein the binding agent comprises a colorant to provide color on a surface of the three-dimensional object.

8. The three-dimensional printing system of claim 7, wherein the binding agent load is assigned to each pixel of the boundary portion by determining an average color of a surface portion of the three-dimensional object represented by the pixel.

9. The three-dimensional printing system of claim 7, wherein the binding agent load assigned to each pixel is based on a location of the pixel in relation to the three-dimensional object.

10. A three-dimensional printing system, comprising a processor and a non-transitory machine-readable storage medium, the non-transitory storage medium comprising instructions to:
slice a three-dimensional model of a three-dimensional object to obtain a layer of the three-dimensional object;
overlay a lattice of pixels over the layer to obtain a grid comprising a plurality of pixels;
define a boundary portion of the grid, wherein the boundary portion represents a surface portion of the three-dimensional object;
assign a binding agent load to the boundary portion based on a first pattern derived from the grid;
define an interior portion of the grid; and
assign a coalescing agent load to the interior portion based on a second pattern derived from the grid.

11. The three-dimensional printing system of claim 10, further comprising a binding agent distributor and a coalescing agent distributor, and wherein the non-transitory machine-readable storage medium further comprises instructions to control the binding agent distributor and the coalescing agent distributor to respectively deliver a binding agent and a coalescing agent onto a layer of build material in patterns and loads defined by the grid.

12. The three-dimensional printing system of claim 10, wherein the boundary portion is defined by at least one of:
pixels containing an outer boundary of the grid when at least half of the area of the pixel is inside the outer boundary;
pixels adjacent to an outermost pixel of the grid; and
pixels within one pixel of an outermost pixel of the grid.

13. The three-dimensional printing system of claim 12, wherein the binding agent comprises a colorant to provide color on a surface of the three-dimensional object.

14. A method, comprising:
slicing a three-dimensional model of a three-dimensional object to obtain a layer of the three-dimensional object;
overlaying a lattice of pixels over the layer to obtain a grid comprising a plurality of pixels;
defining a boundary portion of the grid, wherein the boundary portion represents a surface portion of the three-dimensional object;
assigning a binding agent load to the boundary portion based on a first pattern derived from the grid;
defining an interior portion of the grid; and
assigning a coalescing agent load to the interior portion based on a second pattern derived from the grid.

15. The method of claim 14, further comprising:
providing a layer of build material based on the layer of the three-dimensional object;
matching the grid to the layer of build material;
distributing a binding agent on the boundary portion based on the binding agent load and the first pattern;
distributing a coalescing agent on the interior portion based on the coalescing agent load and the second pattern; and
applying an energy to the layer of build material to cause the interior portion of the layer of build material to coalesce.
